(19) United States
(12) Patent Application Publication
(10) Pub. No.: US 2012/0144157 A1
(43) Pub. Date: Jun. 7, 2012

(54) Allocation of Mainframe Computing Resources Using Distributed Computing

(76) Inventors: James Reginald Crew, Princeton Junction, NJ (US); Pradeep Kumar Reddy Gundavarapu, Rochester, MN (US); Balaji Swaminathan, Chennai (IN); William Donald Pagdin, Anderson, IN (US); Lary Edward Klein, Rochester, MN (US)

(21) Appl. No.: 12/961,336

(22) Filed: Dec. 6, 2010

(51) Int. Cl. G06F 15/76; G06F 9/02

(52) U.S. Cl. 712/30; 712/E09.002

(57) ABSTRACT

There is disclosed a system and method for allocation of mainframe computing resources using distributed computing. In particular, the present application is directed to a system whereby a mainframe process intended for execution on a metered processor may be identified as executable on a non-metered processor. Thereafter, the mainframe computer may initiate execution of the remote process on the remote non-metered processor. If necessary, high-speed access to data available to the metered processor is provided to the non-metered processor. The process operates directly on data available to the metered processor. Once completed, the process signals the mainframe computer that the process is complete. Both metered and non-metered processor configuration and management may be accomplished using the administrative interface.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to the allocation of mainframe computing resources using distributed computing.

2. Description of the Related Art

Mainframe computing has been a mainstay for dealing with large, complex computing processes. Mainframe computing offers many benefits. It employs the most powerful processors in executing processes that involve vast amounts of data. The power of these processors and the associated hardware enable mainframe computers to deal with these large processes in as short a time as possible. Mainframe computers are designed specifically for these types of tasks which may include maintenance of bank records, aggregating data from a number of disparate sources that has been collected throughout the day or computing new balances, averages or other numerical values from large amounts of collected data that change on a daily or hourly basis.

Distributed computing involves the allocation of processing resources to a process using message passing. In many cases, distributed computing entails the use of one or more remote computers to accomplish a common processing task. A distributed computing process might slice up a particularly taxing computing process into a number of different pieces and provide pieces of the process to remote computers connected to a single control computer. The control computer would primarily be responsible for aggregating the results created by the individual remote computers and for communicating with those remote computers in order to ensure that the entirety of the process is completed using whatever computing resources are available. In some cases, distributed computing may mean allocating computing resources among a number of available processors.

### DESCRIPTION OF THE DRAWINGS

FIG. 1 is a diagram of a computer network.

FIG. 2 is a diagram of a mainframe computer and an external computer.

FIG. 3 is a block diagram of the mainframe computer and the job computer.

FIG. 4 is a flowchart of a job request process.

FIG. 5 is a flowchart of a file request process.

FIG. 6 is a flowchart of a mainframe computer process

FIG. 7 is a flowchart of a job computer process.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

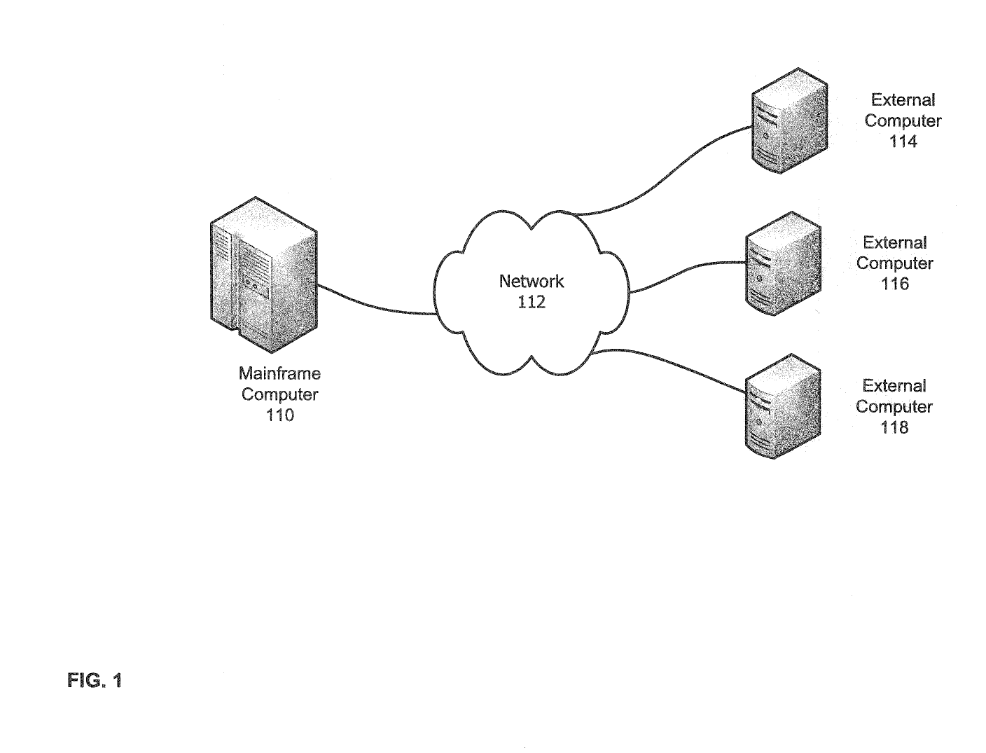

Referring now to FIG. 1, a computer network is shown. A mainframe computer 110 is attached to a network 112. The mainframe computer 110 may be an IBM mainframe using the z/OS operating system. The mainframe computer 110 may include one or more processors.

The mainframe computer 110 may have access to local data as well as one or more databases. The local data may be primarily reserved for software, executable by the mainframe computer 110, the operating system of the mainframe computer 110 and variables related to the operation of the mainframe computer 110 and other software. In addition, parameters related to the execution of programs, process lists, batch process timers and other data may be stored as local data.

The databases available to the mainframe computer 110 may include large data stores upon which the software executable by the mainframe computer 110 acts. These data stores may be DB2 databases accessible to the mainframe computer 110 and other data structures including IMS, ORACLE, VSAM, and sequential files.

The network 112 may take the form of a local network, a wide area network, the Internet or any number of other networks. The network 112 may be implemented locally by physically connected computers or may be distributed over a wide area. Access to the mainframe using the network may require authentication, encryption or other forms of data protection.

The computer network includes external computers 114, 116 and 118. The external computers 114, 116 and 118 may be computers running the Linux operating system. The external computers 114, 116 and 118 may interact with one another and the mainframe computer 110 via the network 112.

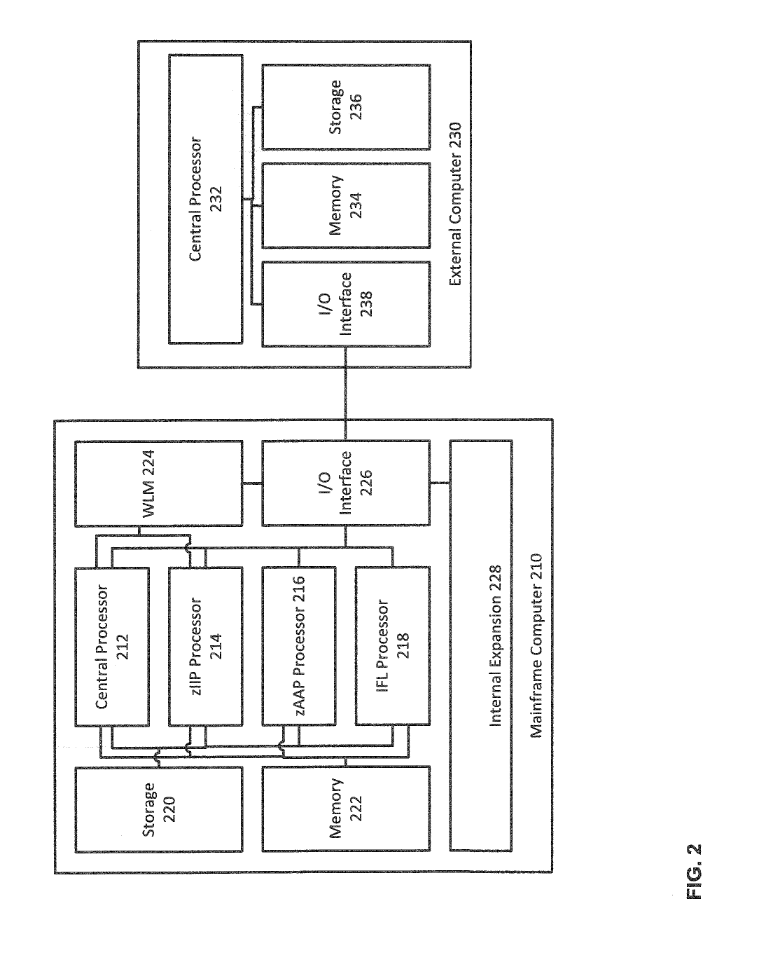

Turning now to FIG. 2, a mainframe computer 210 and an external computer 228 are shown. The mainframe computer 210 may be the mainframe 110 in FIG. 1. The external computer 228 may be one of the external computers 114, 116 and 118 in FIG. 1.

A mainframe computer or mainframe, such as mainframe computer 210, is a large-scale computing device defined by high availability, reliability, large processing throughput, strong security, strict backward compatibility with software and, typically, by high CPU utilization rates, and using large data repositories. All of these capabilities are relative to those of a contemporary personal computer or server. The mainframe computer includes at least one processor for which ongoing utilization is metered. The metering is used by the mainframe provider to charge processor utilization-based software license fees. A metered processor is a processor in the mainframe computer for which utilization-based software license fees are charged.

The mainframe computer also includes high-speed and high-volume input/output connections. A typical modern mainframe is an IBM z10 System running z/OS. A typical mainframe in the 1990s was an IBM System/390 running MVS/ESA. A typical mainframe in the early 1960s was an IBM 700 or 7000 series mainframe and later in the 1960s was an IBM 360.

A metered process is a software process compiled for execution on a metered processor in a mainframe computer. A metered process typically requires high speed access to data files or databases available to the mainframe computer. The high speed access is determined relative to the speed of access available to contemporary personal computers such as the job computer described below. Because it is dedicated to a metered processor, a metered process cannot be executed on a job computer.

The mainframe computer 210 includes a number of mainframe processors such as the central processor 212, the zIIP processor 214, the zAAP processor 216 and the IFL processor 218. The central processor 212 may be a single processor, a group of processor cores operating in concert with one another or a group of interconnected processors operating as a distributed processor through the use of distributed computing hardware or software. Typically, the central processor 212 is a metered processor.

The zIIP processor 214 is a z Integrated Information Processor in an IBM mainframe computer using the z/OS operating system. The zIIP processor 214 enables some applications that are typically run on the central processor 212 to be run on the zIIP processor 214 instead. The mainframe computer 210 may also include a zAAP processor 216 (z Application Assist Processor) and an IFL (Integrated Facility for Linux) processor 218. The zAAP processor 216 is specially designed for executing Java & XML workloads and the IFL processor 218 is a mainframe processor dedicated to running the Linux operating system. The specialty processors 214, 216 and 218 extend the functionality of the central processor 212 of the mainframe computer 210. Multiple specialty processors of each type may be found in a mainframe computer. Additional or different specialty processors may be used by or integrated into the mainframe computer 210. For example, IBM BladeCenter computers may be utilized to provide additional processing capacity.

Because the processing time of the mainframe central processor 212 is a limited commodity, use of other processors, such as specialty processors 214, 216 and 218 is preferred by the mainframe operators when available. If a mainframe operator is able to offload processes traditionally allocated to the central processor 212 to these specialty processors 214, 216 and 218 or to other processors, enhanced availability of the mainframe central processor 212 may result.

The mainframe computer 210 also includes storage 220, memory 222, workload manager 224 and an I/O interface 226. The storage 220 may store one or more databases that enable the storage of vast quantities of data. Typically, these databases utilize one or more methods by which data may be queried and results returned. These databases also typically provide for appending or amending only portions of the data without rewriting the entire data set. Access to the storage 220 may be provided through the use of a secure connection and Internet protocol or any number of other connections. If high-speed connections, such as HiperSockets are used, the data access available to job computers may have virtually no latency.

The memory 222 may be in the form of high speed memory sharable between all processors. Memory 222 may be real, virtual, fetch-protected, private, Common Service Area (CSA), HiperSpace, DataSpace and other memory types. The mainframe computer 210 also connected to storage 220 that may take the form of a Direct Access Storage Device (DASD) or tape or virtual tape devices that are connected to central processor 212 using mainframe Enterprise Systems Connection (ESCON) or Fiber Connectivity (FICON) channels.

The workload manager 224 determines which processor or processors are allocated for particular tasks. In addition, the workload manager 224 works to determine the resources used by each running process and to allocate those processes, using the available resources, so that they are most efficiently performed.

The mainframe computer 210 also includes an I/O interface 226. This interface 226 includes a network interface that may include a wired network such as Ethernet or token ring network and may include access to local networks, a wide-area network and the Internet. The I/O interface 226 includes a connection to at least one job computer such as the IFL processor 218 or the external computer 228. The I/O interface 226 of the mainframe computer 210 also may include wired or wireless input and output to various devices. The I/O interface may communicate by various means with automated teller machines, terminals mainframe access, tape drives, high speed printers and other mainframe input and output devices. Each of the processors 212, 214, 216 and 218 have access to each of the storage 220, memory 222, the workload manager 224 and the I/O interface 226.

The mainframe computer 210 may also include one or more forms of internal expansion 228. This internal expansion may take many forms, but includes at least, the addition of one or more separate computing environments. These separate computing environments may include IBM BladeCenter computers or servers in direct, internal communication with the rest of the mainframe computer 210. The internal expansion may be connected via the I/O interface 226, as shown, or directly connected to the storage 220, memory 222 and other resources available to the mainframe computer 210. The internal expansion 228 provides built-in additional processing availability for the mainframe computer 210. The internal expansion 228 may include one or more computing environments. The operating systems used by the internal expansion 228 may be Linux, Windows, AIX or others.

The external computer 230 has a central processor 232, memory 234, storage 236 and an I/O interface 238. The central processor 230 may also be called a remote processor. The memory 234, storage 236 and I/O interface 238 operate in a manner similar to that of the corresponding elements of the mainframe computer 210. The memory 234 that may take the form of read-only memory (ROM) or random access memory (RAM) or both in combination.

The external computer 230 may include storage 236 such as a hard disk drive, a solid-state drive, a CD-ROM or DVD drive, a high-capacity non-volatile memory, a network storage device such as so-called “cloud” storage or other relatively high-capacity forms of storage. This storage 220 may be a single drive or may be a number of storage units, each connected to the central processor 212 either with a bus or via a network. The I/O interface 236 may include connections to VGA, DVI or DisplayPort output to computer monitors or to displays attached to a mobile device. These may also include input and output means associated with computer mice, keyboards, speaker systems, kinetic feedback, microphones, touchscreens and other input and output devices.

The I/O interface 226 and I/O interface 238 are connected to each other by a network or direct connection. This connection may be a HiperSocket connection that provides very high bandwidth data transfer to the z/OS system running on the mainframe computer 210 resident on the same Central Electronic Complex (CEC). The I/O interface 226 and I/O interface 238 may also connect to a number of other peripherals. The I/O interface 226 may also be simultaneously connected to a number of job computers.

The mainframe computer 210 and the job computer 230 may include additional software and/or hardware for providing functionality and features described herein. The mainframe computer 210 and the external computer 230 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the mainframe computer 210 and the job computer 230 may include various specialized units, circuits, software and interfaces for providing the functionality and features described here. The processes, functionality and features may be embodied in whole or in part in software which operates on the mainframe computer 210 or the IFL processor, or the external computer 230, and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by the mainframe computer 210 or the external computer 230 and others by other devices.

A job computer, such as the external computer 230, the IFL processor 218 and associated storage 220 and memory 222 or one or more internal expansion 228 computing environments, is a computing environment distinct from the central processor in the mainframe. The job computer runs at least one operating system (preferably Linux) on one or more processors or processor cores and capable of executing one or more programs simultaneously. Alternatively, the job computer may use Windows AIX or other operating systems. The job computer includes one or more non-metered processors. A non-metered processor is a processor in a job computer which is not metered.

A remote process is a software process designed for execution on a metered processor, such as the mainframe central processor, but executing or executable on a non-metered processor in one or more job computers in data communication with the mainframe processor. The remote process may be a version of the mainframe software designed for execution on the mainframe central processor but recompiled so as to be executable on a job computer. The software may be recompiled from the source code for the mainframe software using a compiler designed to compile software in a form native to the job computer. Alternatively, the remote process may be a version of software specifically designed to implement functions requiring access to mainframe data.

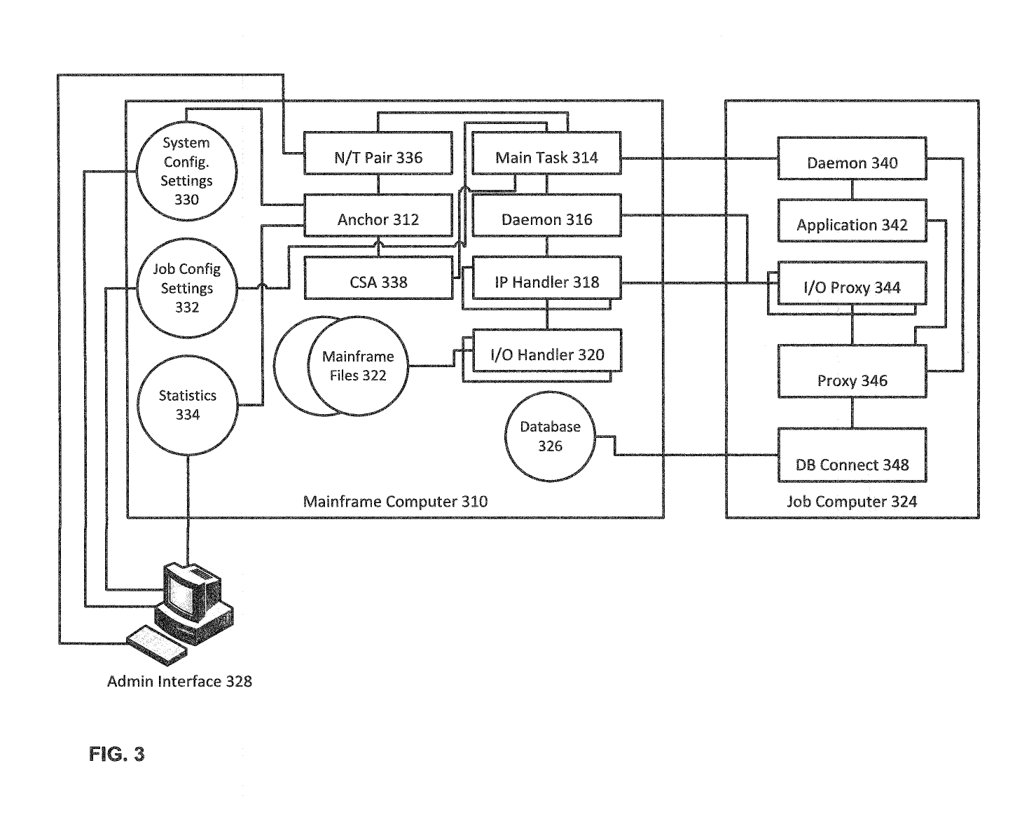

Turning now to FIG. 3, a block diagram of a mainframe computer 310 and a job computer 324 is shown. These may be the mainframe computer 210 and IFL processor 218, respectively, of FIG. 2. Alternatively, the external computer 230 or the internal expansion 228 may be the job computer 324. The mainframe computer 310 has an anchor 312, a main task 314, a daemon 316, an I/O handler 320, mainframe files 322, a database 326, system configuration settings 330, job configuration settings 332, statistics 334, an N/T pair 336 and CSA 338. The elements of the mainframe computer 310 shown as rectangles are software executing as mainframe processes and the elements shown as circles are mainframe data or data available to the mainframe computer 310. The mainframe computer 310 may be accessed by an admin interface 328. The job computer 324 has a daemon 340, application 342, an I/O proxy 344 and a proxy 346 which are remote processes executing on the job computer 324.

The first element of the mainframe computer 310 is the anchor 312. The anchor is a process implemented in software running on the mainframe computer 310 that logs the processes begun and completed and all statistics associated with those processes. The anchor 312 handles the process associated with closing down the various processes at mainframe computer 312 shutdown.

The main task 314 is a process implemented in software and initiated by a job scheduler or job control. A distinct main task 314 is executed for each process request that is allocated to a job computer 324. The anchor 312 and main task 314 may be executed on the central processor 212. In alternative embodiments, the anchor 312 and main task 314 may be executed on the zIIP processor 214 or other specialty processor. Execution on the zIIP processor 214 lowers the number of necessary processing cycles on the central processor 212 and, thus, enables the central processor 212 to be utilized for other tasks.

Each of the main task 314 begins execution of a daemon 316 which in turn executes one or more IP handlers 318 which in turn execute one or more I/O handlers 320. Each of these sub-processes are associated with a process request that is allocated to a job computer 324. Each of the sub-processes may be eligible for execution on one of the specialty processors 214, 216 or 218, though they may be executed on the central processor 212.

Each main task also includes a daemon 316. The daemon 316 is also a sub-process implemented in software and initiated by the main task 314. The daemon 316 enables data communication between the mainframe computer 310 and the job computer 324. In so doing, the daemon 316 interacts with the I/O proxy 344 on a particular job computer 324 to establish a connection. After connection to enable data transfer, the daemon 316 may utilize a number of other sub-processes such as the internet protocol handler 318 and then I/O handler 320 to communicate with the I/O proxy 344. The daemon 316, the internet protocol handler 318 and the I/O handler 320 may be executed in enclave SRB mode and, thus, maybe eligible for execution on the zIIP processor 214. Execution of these processes on the zIIP processor 214 will result in increased availability of the central processor 212 for other processes.

The internet protocol handler 318 is responsible for enabling network communication with the job computer 324. The I/O handler 320 is responsible for utilizing the network channels created and managed by the internet protocol handler 318 to enable data transfer between the mainframe computer 310 and the job computer 324.

The I/O handler 320 has access to the mainframe files 322 that may be needed as the job computer 324 completes remote processes. Using the internet protocol handler 318, the I/O handler 320 also may establish a direct connection between the proxy 346 and the database 326 or other data storage structure. An instance of one internet protocol handler 318 and one I/O handler 320 are allocated for each mainframe file needed by the remote processes running on the job computer 324. Database access is accomplished using a DB connect 348 interface connected to the proxy 346.

The database 326 may be a DB2 database, but other database types of various forms may also be used. The database 326 is a database or data store to which the mainframe computer 310 has access and that includes information necessary to the job computer 324 in order to complete a remote process. Proxy 346 on job computer 324 accesses the database 326 using the DB connect 348, which may include network connectivity mechanisms such as DB2 Data Connect for DB2 databases.

An administrative interface 328 may be used to create system configuration settings 330 for the anchor 312 regarding the main task 314 and the various remote processes that may be executed using the job computer 324. The administrative interface 328 may also be used to create job configuration settings 332 for the anchor and the main task 314 that are associated with each of the individual remote processes that may be executed on the job computer 324. The administrative interface 328 may also be used to adjust ongoing jobs.

The administrative interface 328 also provides access to the statistics 334 compiled by the main task 314 and anchor 312 related to ongoing and completed remote processes. These statistics may include the start and end times of particular jobs or particular types of jobs, the total run time of these jobs, the number of job computers 324 allocated to particular jobs, the speed of input and output between the proxy 346 and the database 326, the total number of files or database entries edited during a job and the number of computing cycles used on the job computer 324 or the mainframe computer 310 to complete a particular job. Other statistics may also be collected and compiled. A name/token pair (N/T pair) 336 and a common service area (CSA) 338 may be used by the main task 314 and anchor 312 in collecting and compiling these statistics. The N/T pair 336 stores and retrieves user-defined information, without the program allocating storage, and is accessed by any address space.

Each of the anchor 312, main task 314, proxy handler 316, IP handler 318 and I/O handler 320 are executed on the mainframe central processor 212. However, specialty processor, such as the zIIP processor 214 may also be used. These processes are executed on the processor that provides the most efficient allocation of computing resources.

The administrative interface 328 can be used to configure and manage both metered and non-metered processors, in addition to job characteristics and statistics. The administrative interface 328 can also be used to direct a process on a non-metered processor to receive and compile a program, prepare its environment to execute the program, archive the program, and perform any other function that may be useful to provide on a non-metered processor. The administrative interface 328 may be restricted according to a data center policy so that some functions may be accessible to only some users.

The job computer 324 includes a daemon 340 that is primarily responsible for accepting and managing remote process requests (or “job requests”) from the main task 314 running on the mainframe computer 310. The daemon 340 accepts parameters related to the remote process from the main task 314, these parameters may have been stored in the job configuration settings 332.

Those parameters are passed by the daemon 340 to the proxy 346. The proxy 346 then passes those parameters to the application 342. The application 342 is an application designed to be implemented on the mainframe 310 or other host system, but compiled so that it may be executed on the job computer 324. The application may be a recompiled version of a mainframe application, may be a new application prepared specifically for a particular task, may be a distributed application that requires access to mainframe data, a Linux application that is under control of a scheduler that requires mainframe monitoring. The application may also be a ported version of a mainframe batch application.

A plurality of applications 342, each directed to different remote processes or “jobs,” may be available on the job computer 324. The daemon 340 accepts job requests and allocates proxy 346 as necessary to deal with various requests. Multiple proxy 346 may be used if necessary to accomplish one or more jobs simultaneously or in parallel with other job computers 324. The proxy 346 selects the appropriate application 342 for a particular remote process in response to a request from the main task 314. The compiler used may be OpenCobol for Linux, Microfocus Cobol or other compiler, including compilers for different programming languages.

The application 324 may require information stored in the mainframe files 322 or the database 326 to complete the remote process. The I/O proxy 344 on the job computer 324 may communicate with the proxy handler 318 in order to establish a network connection or connections to enable access to mainframe data. The I/O proxy 344 hands off the data connection or connections between the mainframe computer 310 and the job computer 324, once established, to the proxy 346.

The proxy 346 also opens communication of mainframe files 322 and the database 326 for the application 342 for read and/or write access to data necessary to complete execution of the remote process. The proxy 346 and database 326 (or mainframe files 322) may be connected by a high speed network connection or a series of high speed network connections. These connections may alternatively use HiperSockets. The proxy 346 enables the application 342 executing on the job computer 324 to have direct access to the database 326 and all data stored therein using the DB connect 348 or similar functionality which is used for all database 326 communication.

The proxy 346 provides similar high speed access to the mainframe files 322. In this way, the proxy 346 may open files, write to files, read from files, accept input and output from files and close files as though they were stored locally. The proxy 346 also may include one or more buffers in order to ensure that high speed data transfer and file operations between the mainframe computer 310 and the job computer 324 are maintained.

Description of Processes

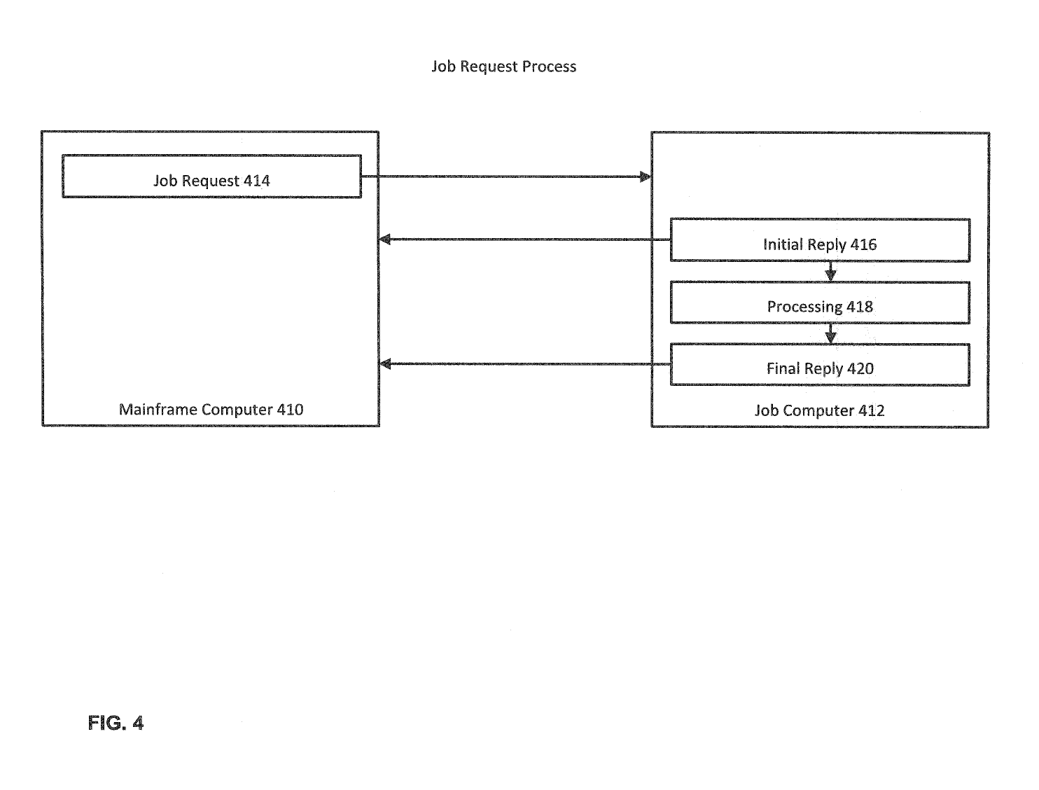

Referring to FIG. 4, a flowchart of a job request process is shown. The flowchart is divided into two portions. The first portion is the mainframe computer 410 portion and the second portion is the job computer 412 portion. The mainframe computer 410 portion includes to the portions of the job request process that take place on the mainframe computer 210 in FIG. 2 or 310 in FIG. 3. The job computer 412 portion includes to the portions of the job request process that take place on the job computer 412.

A job start request 414 initiated on the mainframe computer. At the start of this step, the mainframe computer 414 has been tasked with a process (or “job”) to complete. In many cases, this process will be a batch process requiring access to a data store and may take a substantial amount of time and processor cycles to complete. These types of processes are often given to mainframe computers such as mainframe computer 410 because they may be accomplished most quickly and reliably.

The mainframe computer 410 receives a process request and identifies it as a process suitable for execution on a job computer 412. Once so identified, the mainframe computer 410 sends a job start request 414 to the job computer 412. The job request 414 includes the name of the original process, the location of the corresponding software on the job computer 412, launch parameters for the application that were originally provided to the mainframe software and any additional information necessary to complete the process. For example, if database access is necessary for the process to complete on the job computer 412, the additional information may include the internet protocol address of the database or other information necessary to access the database.

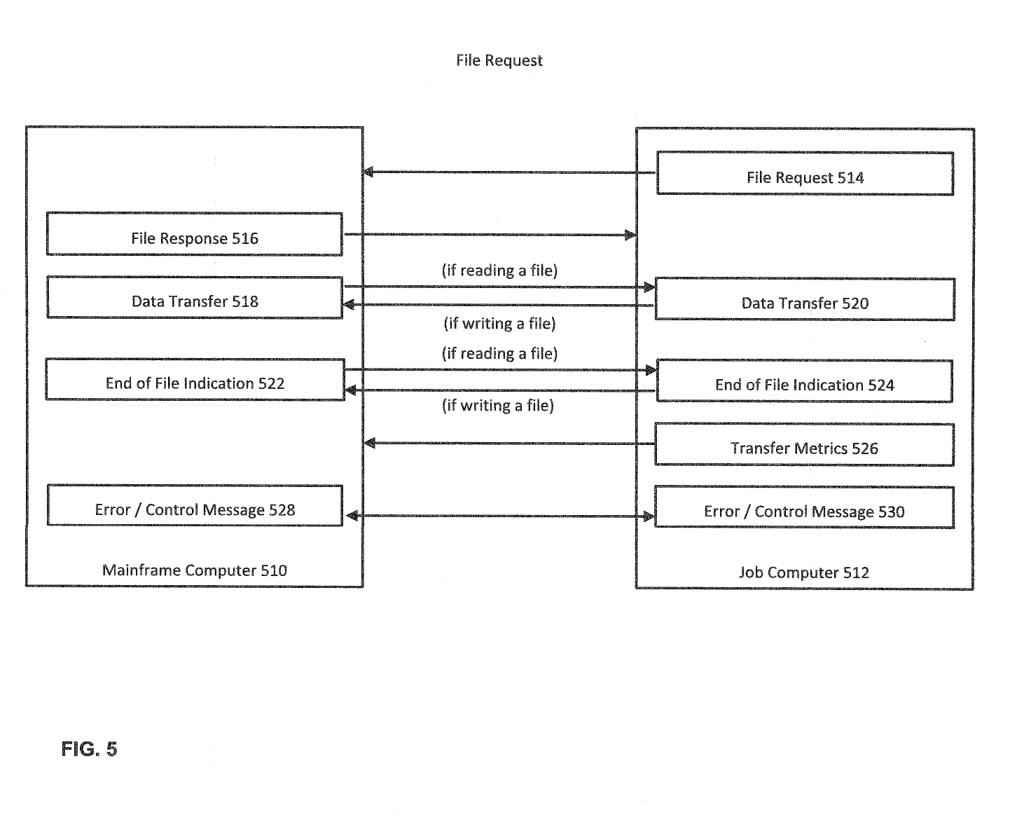

The job computer 412 then provides an initial reply 416. The initial reply 416 includes a confirmation that the job request 414 has been accepted. The next step is processing 418. In this step, the job computer 412 in communication with the mainframe computer 410 completes the process allocated to it by the job request 414. In the course of this processing 418, the job computer 412 may require access to a database or data files on the mainframe computer 410. If necessary to complete processing 418, one or more file transfers, as shown and described below with reference to FIG. 5, may be initiated.

Once the processing 418 is complete, the job computer 412 sends a final reply 420. The final reply 420 includes flags indicating why and how the process completed. For example, the flags may indicate that the job succeeded or failed and, if it failed, why it failed. The final reply 420 also includes statistics related to the completion of the processing 418. These statistics may be related to the speed of the process, the total number of elements edited or any number of other statistics relative to the processing 418.

Turning now to FIG. 5, a flowchart of a file request is shown. The file request flowchart is divided into two portions, one dedicated to the mainframe computer 510 and another dedicated to the job computer 512. The parts of the process shown on the left are executed on the mainframe computer 510. The parts of the process shown on the right are executed on the job computer 512. A plurality of these file request processes may be opened by each remote process.

The remote process on the job computer 512 makes a file request 514. This may be for access to a file stored locally on the mainframe computer 510 or to a database accessible to the mainframe computer 510. This file request 514 may be for sequential or random access to a mainframe file, including physical sequential files and Virtual Storage Access Method (VSAM) files, for reading or for access to a file for writing (or both). The data access is provided on the application layer of the job computer 512 and, therefore, acts as though it is direct, local access to the remote process running on the job computer 512.

The mainframe computer 510 then sends a file transfer response 516. This file transfer response 516 acknowledges the request and initiates file or database access. Then, data transfer 518 (including, read, write, update, close) is initiated. The data transfer 518 may provide data from the mainframe computer 510 to the job computer 512. Alternatively, the data transfer 520 may provide data to the mainframe computer 510 from the job computer 512. In yet another alternative, data may be provided simultaneously or substantially simultaneously to both the mainframe computer 510 and the job computer 512.

Once an end of file indication 522 or 524 is received by the job computer 512 or mainframe computer 510, respectively, the file transfer is complete. The job computer 512 then provides transfer metrics 526 such as the size, speed, start time and end time of the transfer. Other statistics, such as the total number of elements read, written or otherwise operated upon also may be provided.

Then, the mainframe computer 510 and job computer 512 share error and control messages 528 and 530. If the process terminates for any reason other than successful completion of the transfer, these control messages 528 and 530 may indicate the reason for the termination or other information related to the termination. If the process ends successfully, these control messages 528 and 530 may indicate that success.

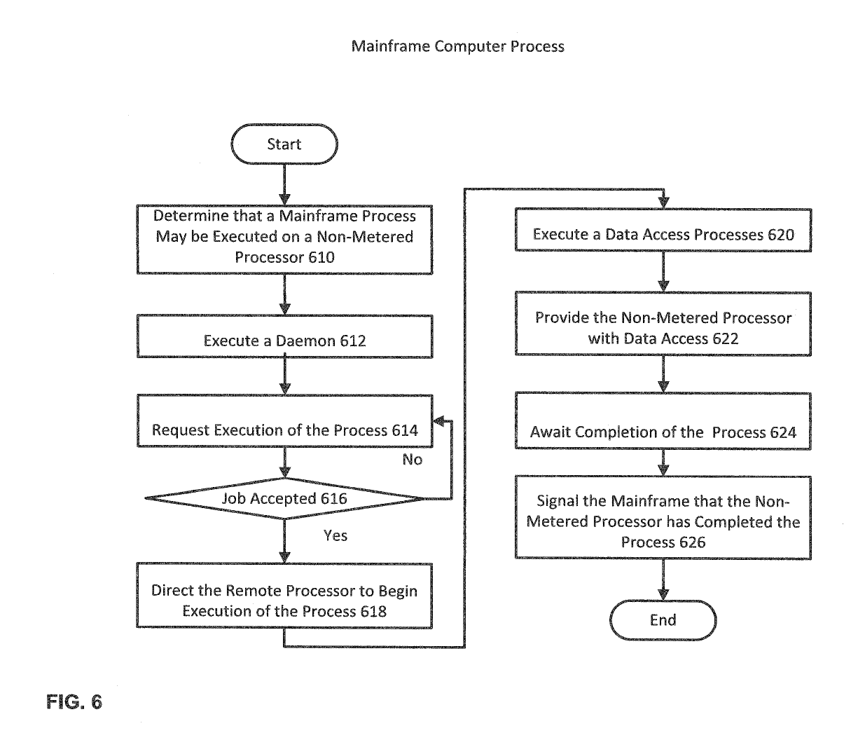

Turning now to FIG. 6, a flowchart of a mainframe computer process is shown. This is the mainframe process executed on the mainframe computer in order to complete the remote process. The mainframe process may be implemented in software executing on a mainframe central processor, such as central processor 212 in FIG. 2 or in one of the specialty processors, such as the zIIP processor 214.

The mainframe computer, such as mainframe computer 210 in FIG. 2, executes a number of processes or jobs on a regular basis. Most of these processes are batch processes operating on a large data set. The processes are initiated at a set time, typically late at night, and run until completed. Once completed, additional batch processes are often run in or parallel or in a sequence managed by a job scheduler. Some or all of these processes may be eligible to be executed on a remote processor.

As a first part of this process, software executing on the mainframe computer determines that a mainframe process may, instead, be executed on a non-metered processor 610. Preferably, the determination is made when the process is begun on the mainframe computer and, after checking a configuration file, it is determined that the process is eligible for execution on a job computer and that software exists on the job computer to enable execution on the job computer.

The job may be identified based upon the processor utilization required to execute the job. A job control language (JCL) change replaces the original application to be executed by the mainframe with the name of the main task 314. The main task 314 will utilize the name of the original application and other job information as-necessary as an identifier that may be used to read job configuration settings 332 associated with a particular application 342 which in turn may be used to launch the appropriate remote application.

Once this determination is made, the mainframe computer executes a daemon 612 that enables the mainframe computer to pass parameters to the job computer for non-metered processing. The daemon, such as daemon 316 in FIG. 3, may also be described as a control process. The main task also reads relative path, full path or file name and any flags necessary to begin the batch process and prepares to pass those on to the remote process. Preferably, the daemon 612 is executed on a specialty processor other than the central processor 212. However, the daemon may be executed 612 on the central processor 212.

At this point, the mainframe computer requests remote execution of the process 614. This may involve the selection of one or more job computers. The mainframe computer then communicates via the daemon with those job computers to pass parameters, flags, and to request that those job computers begin execution of the process. If, for any reason, execution of the process is refused by the proposed target job computer or fails, execution of the process 614 is requested again of another job computer. Once accepted, the mainframe process continues.

If the job was accepted 616, the job computer on which the process was accepted is directed to beginning execution of the process 618. At this stage, all parameters necessary to complete the process are passed to the process using the daemon 612. The non-metered processor begins execution of the remote process according to the description provided with regard to FIG. 4.

Access to data available to the mainframe may be necessary to complete the process. The system of the present application enables high-speed, direct access to data using a data access process and buffers. In this way, the remote process running on the job computer may access data available to the mainframe with little or no delay. To enable this data access, a data access process is executed 620 on the mainframe computer. The data access process is actually a process and series of sub-processes including the proxy handler 316, the IP handler 318, and the I/O handler 320 that enable the process executing on the job computer to read and write to mainframe data necessary for execution. One or more corresponding data access processes may be executed on the job computer. Together these processes enable high-speed, direct access by the remote process to mainframe data. In addition, these data access processes use buffers to ensure that high-speed data access is maintained.

Once the data access processes are executing, any data necessary to complete the remote process is provided to the non-metered processor 622. This data access process is then executed in conformity with FIG. 5 and is described above. Several different files or databases may be necessary to complete execution of the remote process. If so, the non-metered processor may be provided with data access 622 to numerous files or databases simultaneously or in serial before the remote process completes. A unique data access process is used to provide access to each file or database.

The mainframe then awaits completion of the process 624. Once the process is completed and all relevant files updated, the mainframe is signaled that the remote processor has completed the remote process 626. Then, the mainframe computer may proceed to the next process in the queue of processes to be completed.

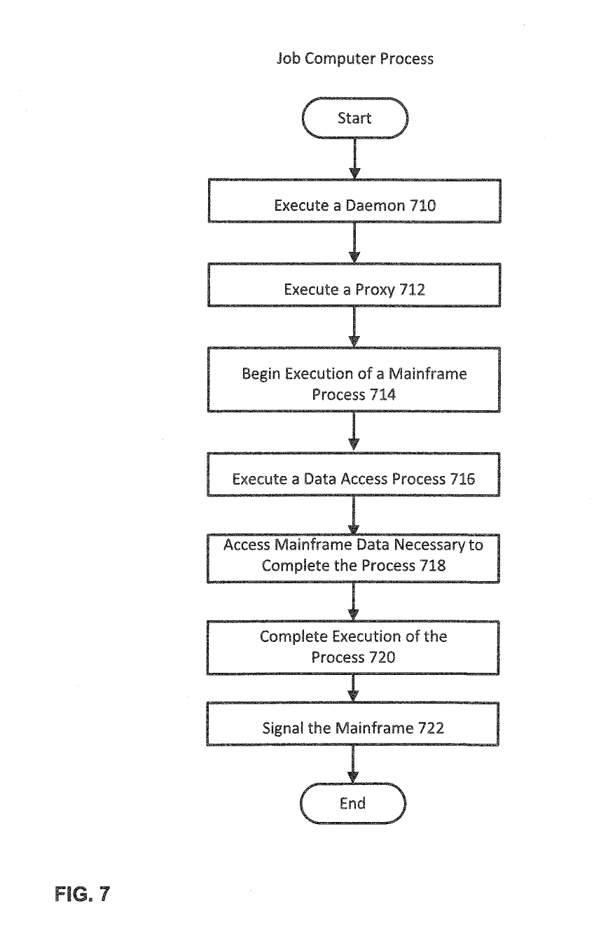

Turning now to FIG. 7, a flowchart of a job computer process is shown. This is the overall process undertaken by the job computer in order to complete the process on the job computer. This process acts in concert with the mainframe process of FIG. 6. The client process may be implemented using the IFL processor 218, an external computer 230 or the internal expansion 228.

The job computer process begins with the execution of a daemon 710. This daemon may be executed on a scheduled basis or as initiated by another daemon. This daemon 710 may be used to accept connections from the central processor 212 and, if necessary, to launch the proxy on the job computer. The next step is for the daemon to execute a proxy 712. A single proxy is executed for each job request. The proxy 712 then allocates resources for its associated remote process. The proxy 712 then uses the job request received from the central processor to begin execution of a mainframe process as a remote process 714 under the control of the proxy

The remote process may require access to data available to the mainframe computer to execute. Accordingly, one or more data access processes are executed 716 by the proxy, as needed, which connects to the data access process on the mainframe computer and provides high-speed, direct access to mainframe computer files and databases. The data access process executed 718 is actually the I/O proxy 344 and the proxy 346 working in concert, as described above, to enable access by the remote process executing on the job computer to mainframe files and databases.

To the extent necessary, the process accesses the mainframe data necessary to complete the process 718. This may require access to multiple files or databases simultaneously or in serial. A new data access process is executed 716 for each such data access necessary. In this way, the data access processes may be dynamically allocated when needed and de-allocated when no longer necessary. This serves to conserve bandwidth and processing time on both the mainframe computer and the job computer as the process is executing.

The process is then completed by the remote processor 720. Once complete, statistics related to the remote process are gathered. These may include statistics pertaining to the start and stop time of the remote process, the total number of files or tables updated, the total bandwidth and estimated connection speed used for data exchange and other similar statistics. These statistics may be provided to the mainframe computer. The job computer then signals the mainframe 722 that the process is complete so that the mainframe computer may proceed to additional processes in its queue.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments. Processes are described herein as a series of steps. However, these steps may be accomplished in different orders, simultaneously or concurrently. “Simultaneously” means “at exactly the same time.” “Concurrently” means “within the same time.”

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method of operating a mainframe, the mainframe comprising a general purpose computer having plural processors which support plural simultaneous programs and high volumes of concurrent transaction processing and wherein ongoing utilization of at least one of the plural processors is metered, the method comprising:
(a) capturing an initiation request, wherein the initiation request is a request to initiate a process on a metered processor in the mainframe, wherein the process requires data available to the metered processor;
(b) determining that the process is executable on a non-metered processor;
(c) causing the process to begin executing on the non-metered processor;
(d) causing the mainframe to provide the non-metered processor with access to the data available to the metered processor and required by the process executing on the non-metered processor;
(e) receiving a signal from the non-metered processor that execution of the process has completed; and
wherein the method is performed by one of the plural processors in the mainframe.

2. The method of claim 1 wherein the non-metered processor is external to the mainframe.

3. The method of claim 1 wherein elements (a), (b), (c), (d) and (e) occur concurrently.

4. The method of claim 1 wherein elements (a), (b), (c), (d) and (e) occur in any order.

5. The method of claim 1 further comprising providing parameters for the process to the non-metered processor.

6. The method of claim 1 further comprising logging of the operation and statistics related to the completed process.

7. The method of claim 1 wherein the data available to the metered processor is converted into a form for use by the non-metered processor.

8. The method of claim 1 wherein the operation of the non-metered processor may be controlled using an administrative interface.

9. The method of claim 1 wherein the software executing the process on the non-metered processor may be compiled and configured for the non-metered processor using an administrative interface.

10. The method of claim 1 wherein the workload of the non-metered processor is managed by the metered processor.

11. The method of claim 1 wherein the non-metered processor is unavailable to execute the process and the metered processor completes the process.

12. The method of claim 1 wherein a mainframe data proxy is used to provide the non-metered processor with access to the data available to the metered processor and required by the process executing on the non-metered processor and is executed in enclave SRB mode on a non-metered specialty processor in the mainframe.

13. The method of claim 1 wherein the data required by the process executing on the non-metered processor is stored in a database available to the metered processor and further wherein a connection to the data is established prior to causing the process to begin executing on the non-metered processor.

14. A method of operating a non-metered processor, the non-metered processor comprising a general purpose processor which supports plural simultaneous programs, the method comprising:
(a) initiating execution of a process in response to an initiation request, wherein the initiation request is a request to initiate a process on a metered processor, wherein execution of the process requires data available to the metered processor;
(b) accessing the data available to the metered processor and required by the process executing on the non-metered processor;
(c) generating a signal to the metered processor that the non-metered processor has completed execution of the process; and
wherein the method is performed by the non-metered processor.

15. The method of claim 14 wherein the initiation request includes parameters for the process.

16. The method of claim 14 wherein the data available to the mainframe includes data local to the mainframe and data stored in databases accessible to the mainframe.

17. The method of claim 14 wherein the process is a batch process and high speed data access to the data available to the mainframe is required to complete execution of the process.

18. The method of claim 14 wherein elements (a), (b) and (c) occur concurrently.

19. The method of claim 14 wherein elements (a), (b) and (c) occur in any order.

20. The method of claim 14 further comprising providing statistics related to the completed process to an administrative device.

21. The method of claim 14 wherein the data available to the metered processor is converted into a form for use by the non-metered processor.

22. The method of claim 14 wherein the software executing the process on the non-metered processor may be compiled and configured for the non-metered processor using an administrative interface.

23. The method of claim 14 wherein the non-metered processor is unavailable to execute the process and the metered processor completes the process.

24. The method of claim 14 wherein the data required by the process executing on the non-metered processor is stored in a database available to the metered processor and further wherein a connection to the data is established prior to causing the process to begin executing on the non-metered processor.

25. A system comprising a mainframe, the mainframe comprising a general purpose computer having plural processors which support plural simultaneous programs and high volumes of concurrent transaction processing and wherein ongoing utilization of at least one of the plural processors is metered, the mainframe having software which when executed by one of the plural processors causes the processor to:
(a) capture an initiation request, wherein the initiation request is a request to initiate a process on the metered processor in the mainframe, wherein the process requires data available to the metered processor;
(b) determine that the process is executable on a non-metered processor;
(c) cause the process to begin executing on the non-metered processor;
(d) cause the mainframe to provide the non-metered processor with access to the data available to the metered processor and required by the process executing on the non-metered processor; and
(e) receive a signal from the non-metered processor that the non-mainframe has completed execution of the process.

26. The system of claim 25 wherein at least one sub-process enables communication between the metered processor and the non-metered processor regarding the process.

27. The system of claim 26 wherein at least one sub-process enables asynchronous access to the data available to the metered processor by the non-metered processor.

28. The system of claim 25 further comprising a non-metered processor including software which when executed by the non-metered processor causes the non-metered processor to:
(f) initiate execution of the process in response to the initiation request captured by the metered processor, wherein execution of the process was requested on the metered processor and the process requires data available to the metered processor;
(g) access the data available to the metered processor and required by the process executing on the non-metered processor; and
(h) generate a signal to the metered processor that the non-metered processor has completed execution of the process.

29. The system of claim 28 wherein the software executing the process on the non-metered processor may be compiled and configured for the non-metered processor.

30. The system of claim 28 wherein elements (a), (b), (c), (d), (e), (f), (g) and (h) occur concurrently.

31. The system of claim 28 wherein elements (a), (b), (c), (d), (e), (f), (g) and (h) occur in any order.

32. The system of claim 28 wherein the metered processor provides parameters for the process to the non-metered processor.

33. The system of claim 28 wherein the metered processor logs statistics of the operation and statistics related to the completed process.

34. The system of claim 28 wherein the data available to the metered processor is converted into a form for use by the non-metered processor.

35. The system of claim 28 further including an administrative device to control the operation of the non-metered processor.

36. The system of claim 28 wherein the workload of the non-metered processor is managed by the metered processor.

37. The system of claim 28 wherein the metered processor completes the process if the non-metered processor is unavailable to execute the process.

38. The system of claim 28 further including a mainframe data proxy that provides the non-metered processor with access to the data available to the metered processor and required by the process executing on the non-metered processor and wherein the mainframe data proxy is executed in enclave SRB mode on a non-metered specialty processor in the mainframe.

39. The system of claim 28 further comprising a database available to the metered processor stores the data required by the process executing on the non-metered processor and wherein a connection to the data is established prior to causing the process to begin executing on the non-metered processor.
